(19) United States
(12) Patent Application Publication
(10) Pub. No.: US 2026/0164236 A1
(43) Pub. Date: Jun. 11, 2026

(54) USER AUTHENTICATION VIA CONNECTED EQUIPMENT

(71) Applicant: AT&T Intellectual Property I, L.P., Atlanta, GA (US)

(72) Inventors: Nigel Bradley, Canton, GA (US); Walter Cooper Chastain, Atlanta, GA (US); Sheldon Kent Meredith, Roswell, GA (US); Zhi Cui, Sugar Hill, GA (US)

(73) Assignee: AT&T Intellectual Property I, L.P., Atlanta, GA (US)

(21) Appl. No.: 18/975,307

(22) Filed: Dec. 10, 2024

(51) Int. Cl. H04W 12/06; H04W 12/61; H04W 12/64

(52) U.S. Cl. CPC H04W 12/06; H04W 12/61; H04W 12/64

(57) ABSTRACT

Aspects of the subject disclosure may include, for example, defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created. Other embodiments are disclosed.

### FIELD OF THE DISCLOSURE

The subject disclosure relates to a user authentication via connected equipment.

### BACKGROUND

Network service technicians often face challenges in efficiently and securely accessing customer premises for installation and repair appointments. Traditional methods of authentication and access control can be cumbersome and time-consuming, leading to delays and potential security vulnerabilities. Existing methods lack the flexibility and security required to handle various conditions, such as remote locations, specific time frames, and the presence of third-party users.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A-2L are block diagrams illustrating example, non-limiting embodiments of systems functioning within the communication network of FIG. 1 in accordance with various aspects described herein.

FIG. 2M depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for creating a temporary bonding relationship between a user(s) (e.g., a field technician such as a network service technician) and equipment (such as a vehicle or tool), enabling proxy authentication of each other. This proxy authentication allows for sharing of permissions including access to customer premises and facilitates communication with the customer during installation or repair appointments. In one or more embodiments, the system and methodology include user-vehicle proxy apps. For example, both the user (e.g., technician) and the equipment (e.g., vehicle) are equipped with wireless connectivity capabilities (which can include near field capabilities, cellular capabilities, and so forth) and a user-vehicle proxy app.

In one or more embodiments, the system and methodology include biometric sensors. For example, the equipment (e.g., the vehicle) is equipped with biometric sensors to collect biometric data from the user.

In one or more embodiments, the system and methodology include nearfield communication. For example, the user device and the vehicle have nearfield communication capabilities using Bluetooth or other standard NFC protocols.

In one or more embodiments, the system and methodology include a user-vehicle proxy server. For example, the apps communicate with a user-vehicle proxy server, which has access to various database information for generating and managing bonding relationships.

In one or more embodiments, the system and methodology include conditional bonding. For example, the bonding relationship can be defined by conditions such as time, location, and the presence of a third-party authenticator.

In one or more embodiments, the system and methodology include proxy authentication. For example, the system provides proxy authentication of the vehicle by the technician based on the existence of the created bonding relationship.

In one or more embodiments, the system and methodology include improving over previous approaches by providing a convenient and efficient solution for temporary authentication between a user (e.g., field technician) and equipment (e.g., a vehicle), enabling secure access and communication for service appointments. The use of biometric sensors, nearfield communication, and conditional bonding adds layers of security and flexibility, making the system robust and adaptable to various scenarios. Other embodiments are described in the subject disclosure.

In one embodiment, the system and methodology provide for or otherwise enables a network service technician to be a proxy to authenticate a vehicle and vice versa. By establishing and managing a relationship between a technician and a vehicle, this proxy authentication may take place. The authentication may exist for only the duration of a temporary relationship (such as an installation or repair appointment), may apply to conditions when the user is located in a remote location from the vehicle, and/or may only exist when other conditions apply, such as being in an expected location at an expected time, or having a 3rd party user being either physically or virtually present. This authentication allows for access to the customer premises, enables connectivity to the customer, and satisfying other customer needs.

In one or more embodiments, a method is provided for creating a temporary bonding relationship between a service provider technician and a vehicle, comprising: receiving data defining an allowed bonding relationship between the service provider technician and the vehicle; receiving a request from the service provider technician to activate the allowed bonding relationship; validating the request; and storing data indicating that the allowed bonding relationship has been created. The data defining the allowed bonding relationship can include a time condition. The data defining the allowed bonding relationship can include a location condition. In one embodiment, a proxy authentication of the vehicle can be provided by the service provider technician based at least in part on the existence of the created bonding relationship.

One or more aspects of the subject disclosure include a method, comprising receiving, by a processing system including a processor, data associated with at least one of a user or a vehicle. The method can include defining, by the processing system and according to the data, an allowed bonding relationship between the user and the vehicle, wherein the defining the allowed bonding relationship includes generating a time condition and a location condition. The method can include receiving, by the processing system from a communication device, a request to activate the allowed bonding relationship. The method can include validating, by the processing system, the request. The method can include activating, by the processing system, the allowed bonding relationship based on the validating. The method can include storing, by the processing system, activation information indicating that the allowed bonding relationship has been created.

One or more aspects of the subject disclosure include a device, comprising a processing system including a processor; and a memory that stores executable instructions that, when executed by the processing system, facilitate performance of operations. The operations can include defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications. The operations can include receiving, from an end user device of the user, a request to activate the allowed bonding relationship. The operations can include validating the request. The operations can include activating the allowed bonding relationship based on the validating, the time condition and the location condition. The operations can include storing activation information indicating that the allowed bonding relationship has been created.

One or more aspects of the subject disclosure include a non-transitory machine-readable medium, comprising executable instructions that, when executed by a processing system including a processor, facilitate performance of operations. The operations can include defining an allowed bonding relationship between a user and a vehicle, where the defining the allowed bonding relationship includes generating a time condition and a location condition. The operations can include receiving, from a communication device, a request to activate the allowed bonding relationship. The operations can include validating the request. The operations can include activating the allowed bonding relationship based on the validating, the time condition and the location condition. The operations can include storing activation information indicating that the allowed bonding relationship has been created.

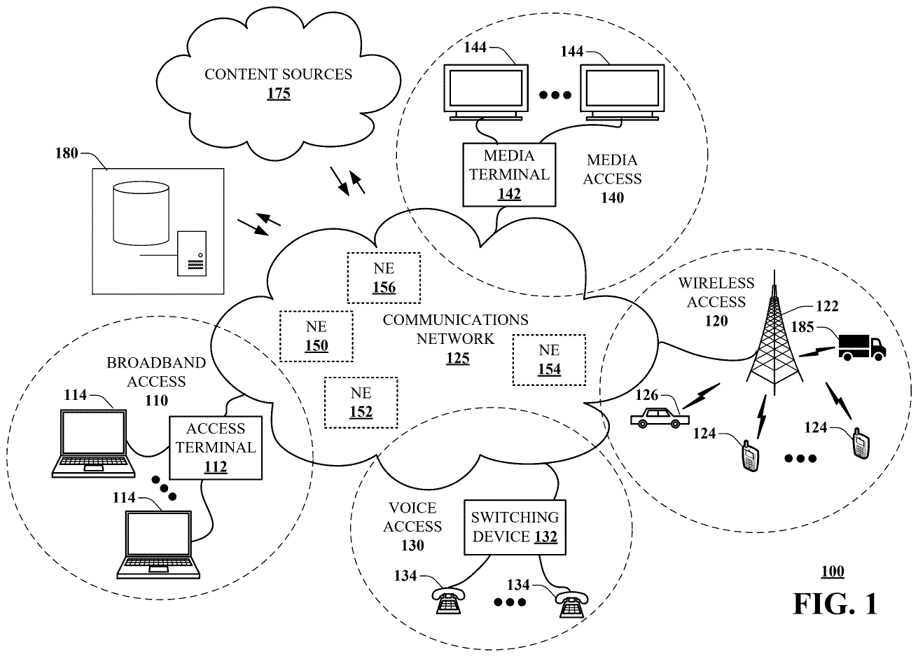

Referring now to FIG. 1, a block diagram is shown illustrating an example, non-limiting embodiment of a system 100 in accordance with various aspects described herein. System 100 can include a bonding relationship/authentication platform 180 and equipment of an entity (illustrated as vehicle 185). The platform 180 can interact with the vehicle 185 to provide services to a customer, such as at a residence, through the use of a user-vehicle proxy app. For example, the vehicle 185 can be equipped with a user-vehicle proxy app that communicates with the authentication platform 180. The technician's device, such as a smartphone or wearable, also can have the user-vehicle proxy app installed. The vehicle 185 can be equipped with biometric sensors that collect biometric data from the technician. This data can be used to authenticate the technician's identity. In one embodiment, Nearfield Communication (NFC) can be utilized. For example, the technician's device and the vehicle 185 can use NFC capabilities, such as Bluetooth, to establish a secure communication link.

The user-vehicle proxy app on both the technician's device and the vehicle 185 can communicate with the user-vehicle proxy server, which is part of the authentication platform 180. The server can have access to various databases containing authentication and authorization information, which can be associated with the user, the vehicle (or equipment), the services to be performed, the customer, the customer's premises, and so forth. The authentication platform 180 can define the conditions for the bonding relationship between the technician and the vehicle 185. These conditions may include specific time frames, locations, permissions, and/or requirements for the presence of a third-party authenticator.

Once the bonding relationship is established, the authentication platform 180 can provide proxy authentication of the vehicle 185 by the technician. This allows the vehicle 185 to act on behalf of the technician (or vice versa) for accessing customer premises, communicating with the customer or otherwise providing services to the customer.

The authenticated vehicle 185 can now interact with the customer's access terminal (e.g., terminal 112 via the communications network 125). In the case of installation or repair of communication services, this interaction may involve accessing broadband services 110, wireless access 120, voice access 130, or media access 140 to provide the necessary services at the customer's residence when the platform 180 is being utilized in conjunction with a communications network. The vehicle 185, now authenticated, can securely access the customer's premises and facilitate effective communication between the technician and the customer. This ensures that the technician can perform installation or repair tasks efficiently and securely. By leveraging the authentication platform 180, the vehicle 185 can provide secure and efficient services to customers, ensuring that network service technicians can access customer premises and communicate effectively during service appointments.

For example, system 100 can facilitate in whole or in part defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

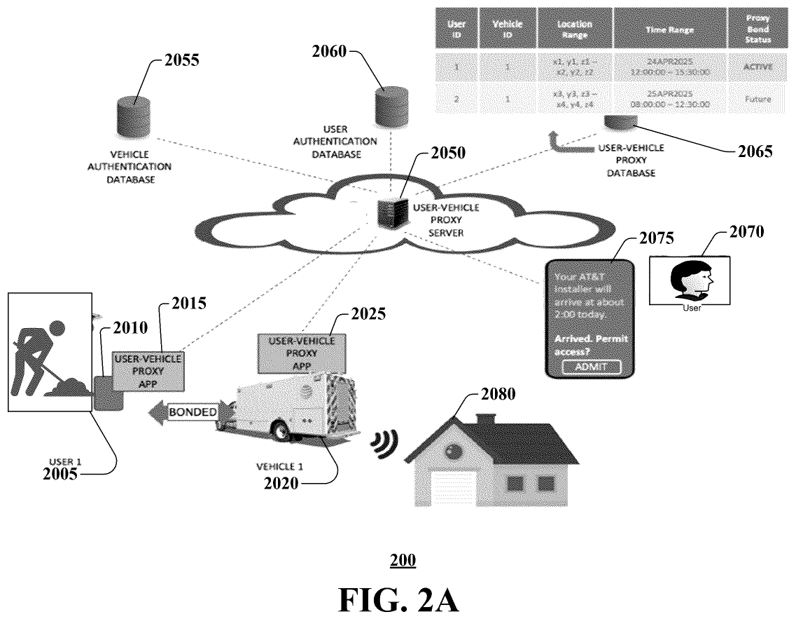

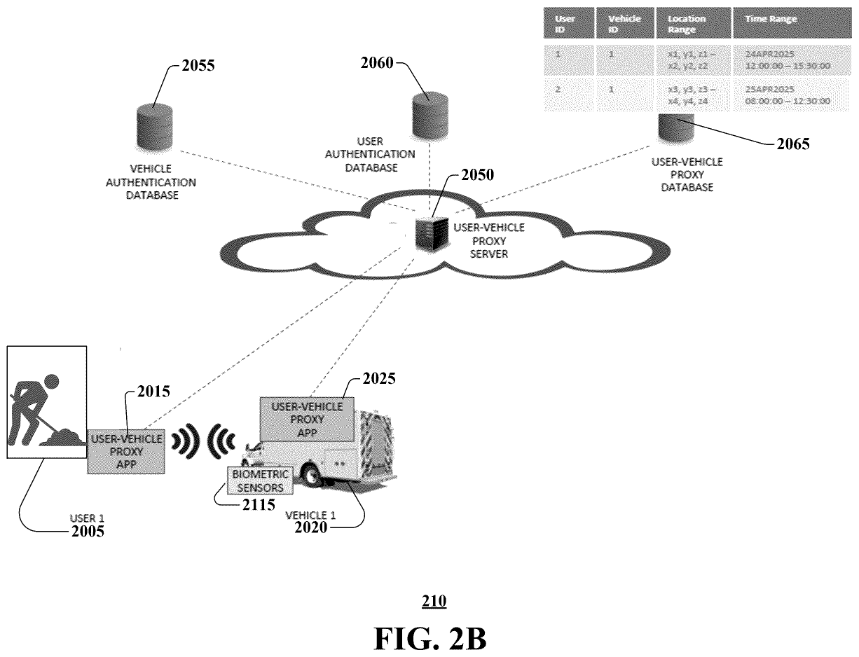

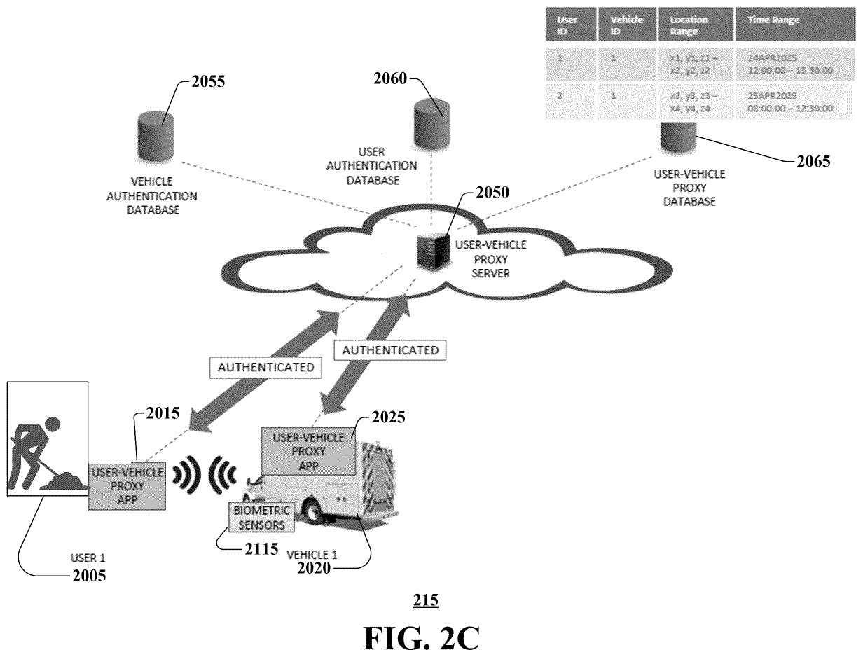

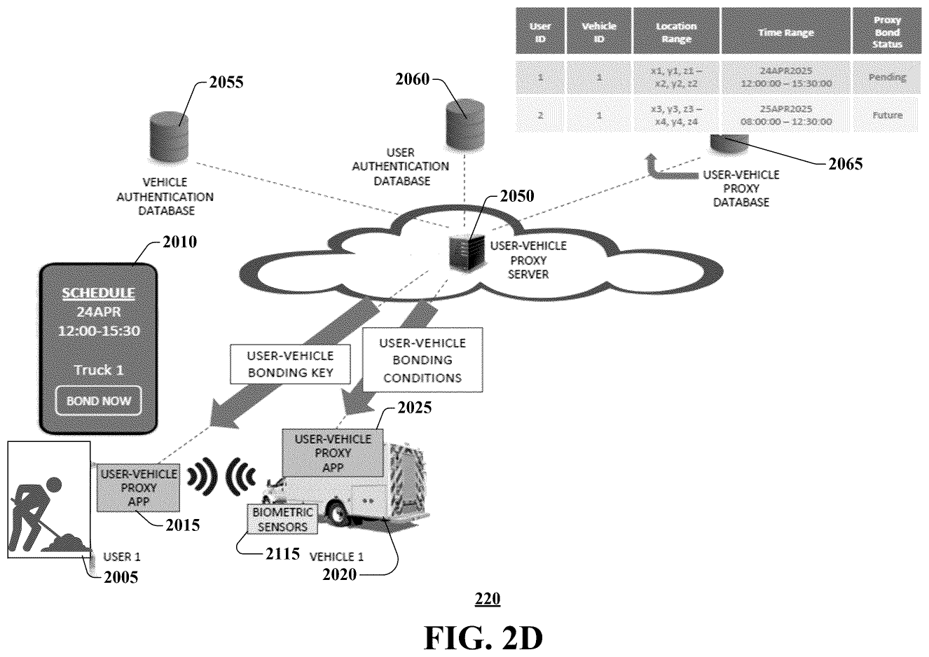

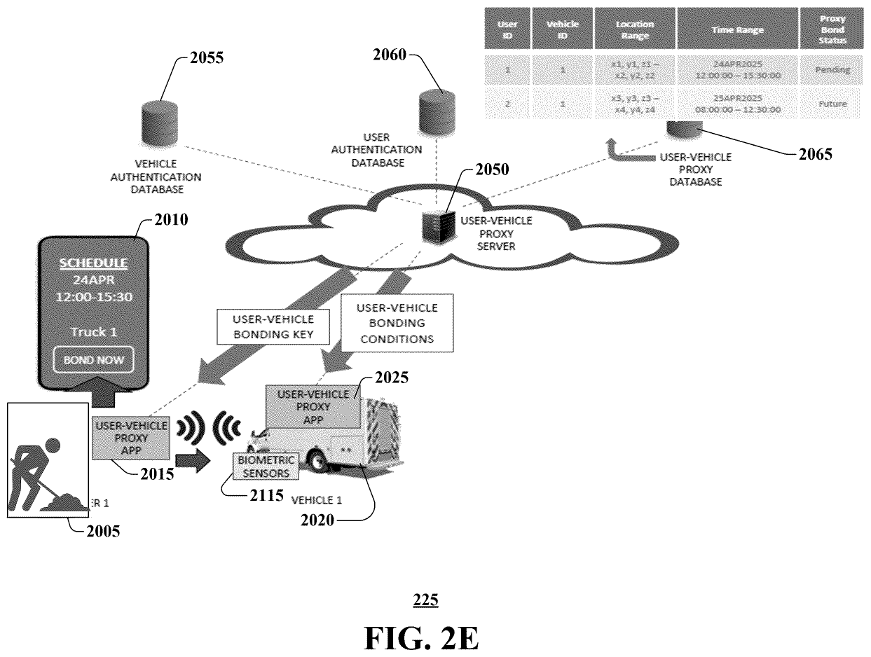

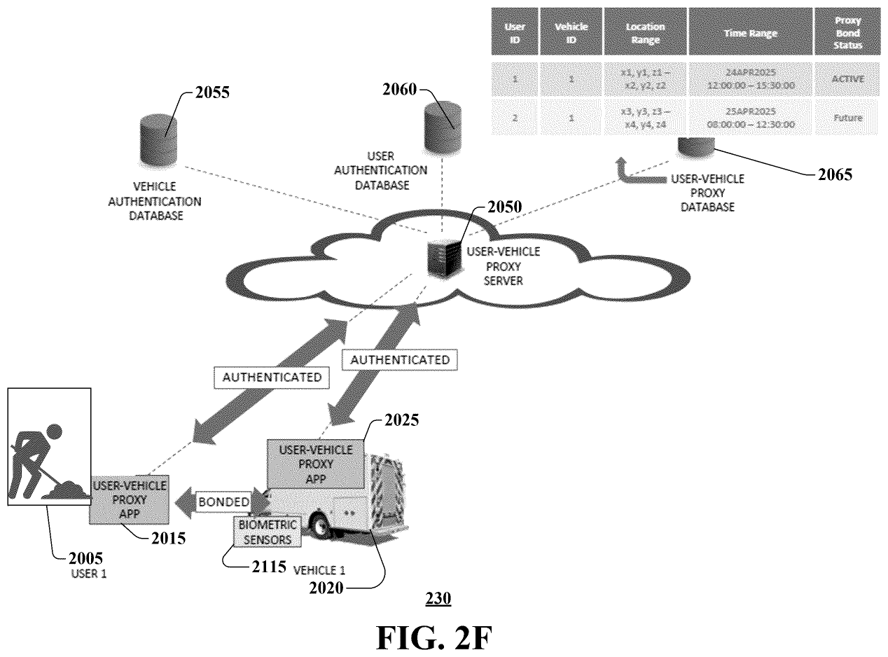

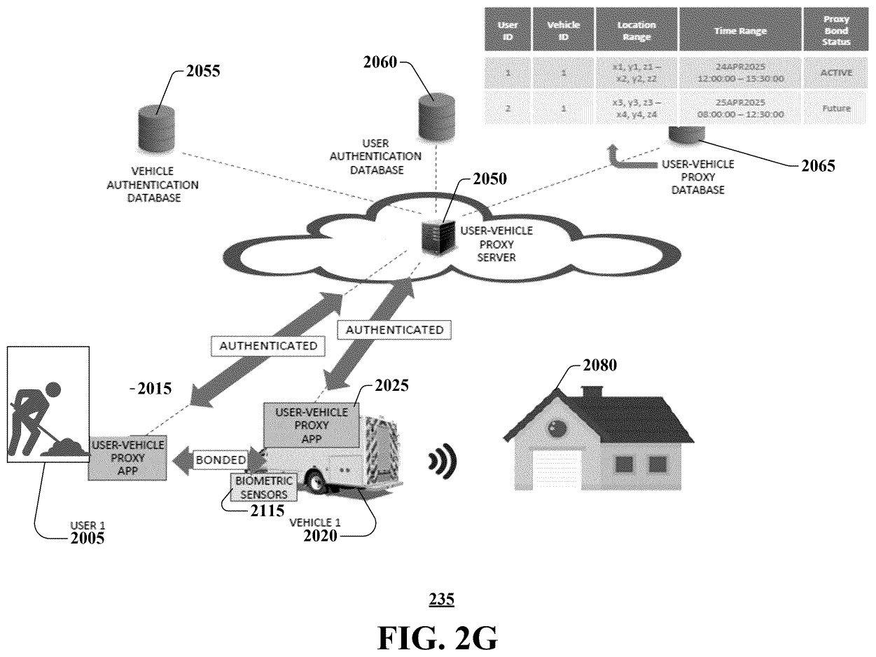

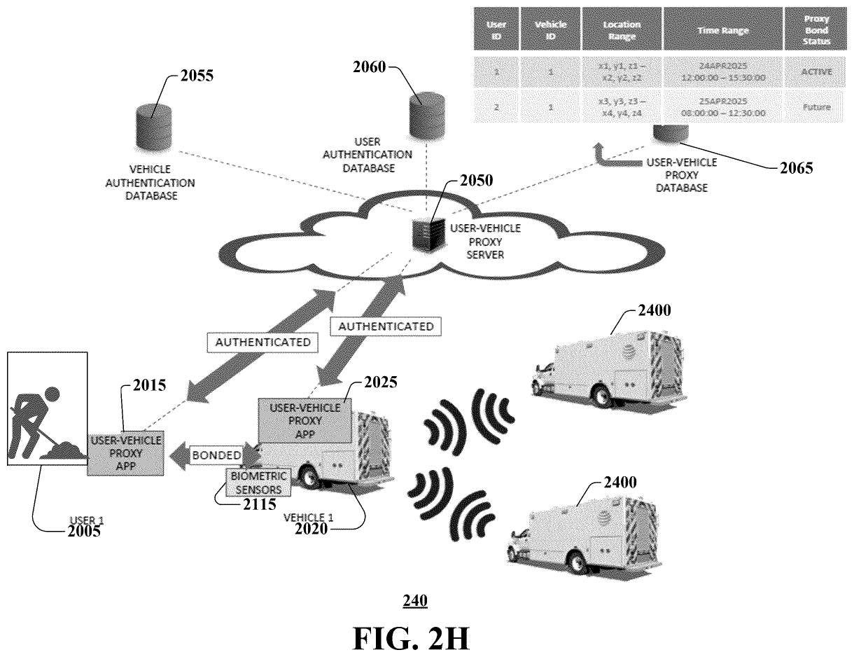

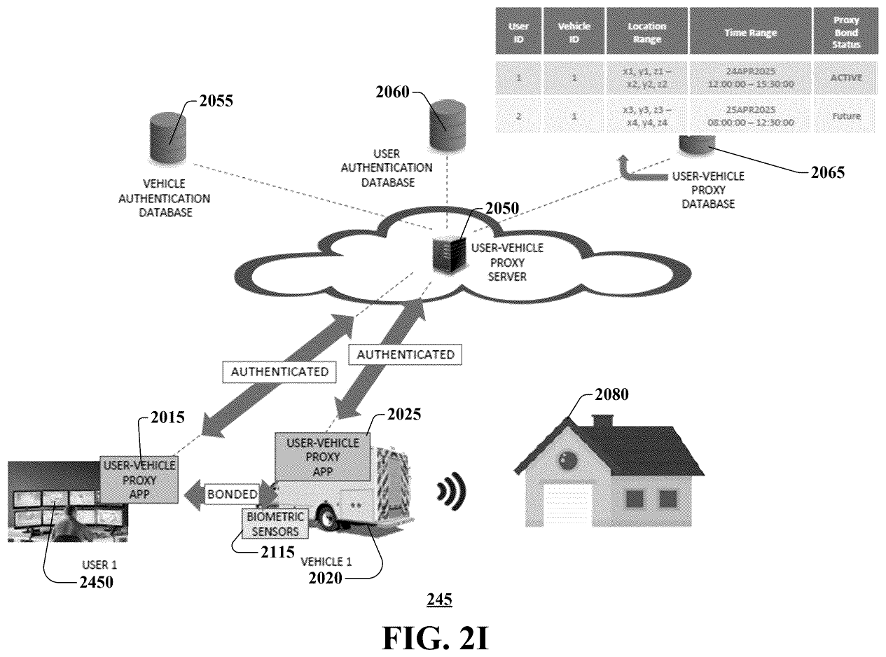

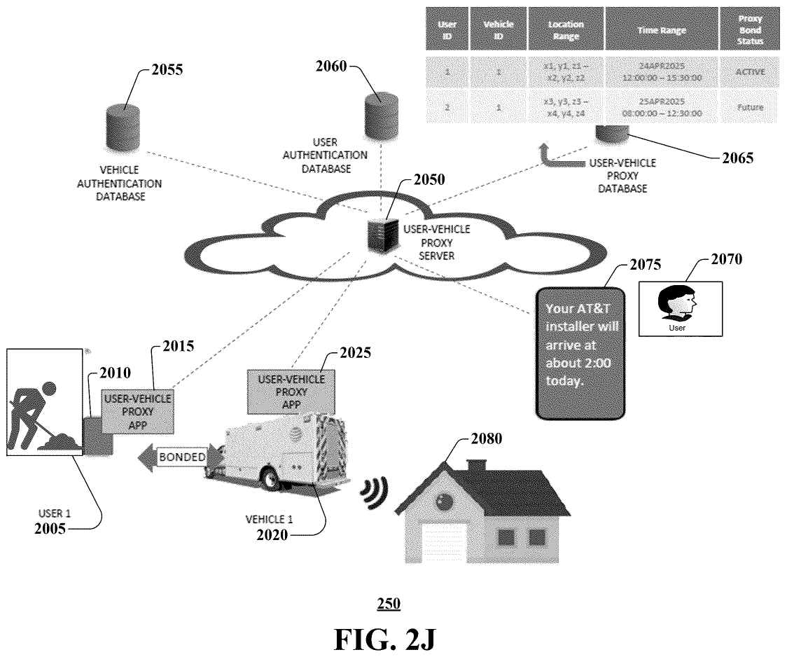

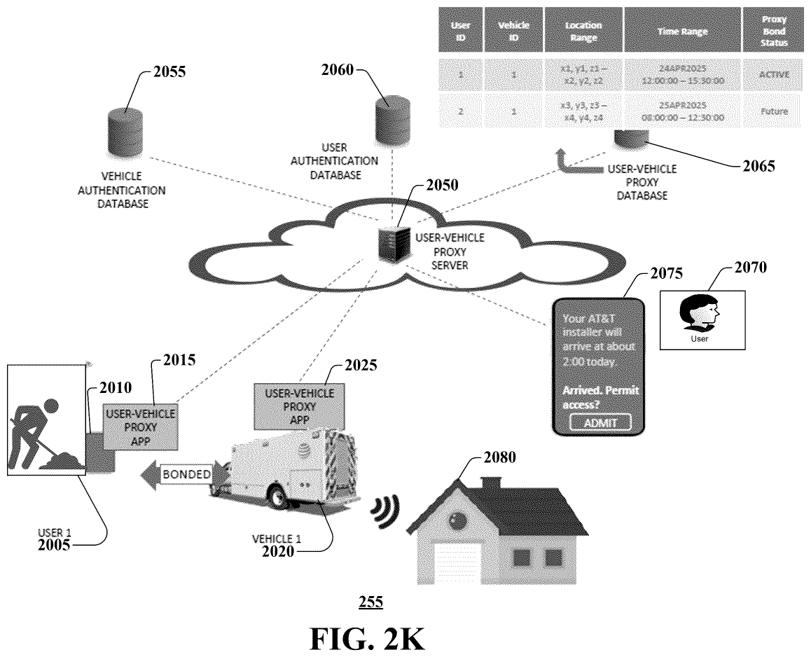

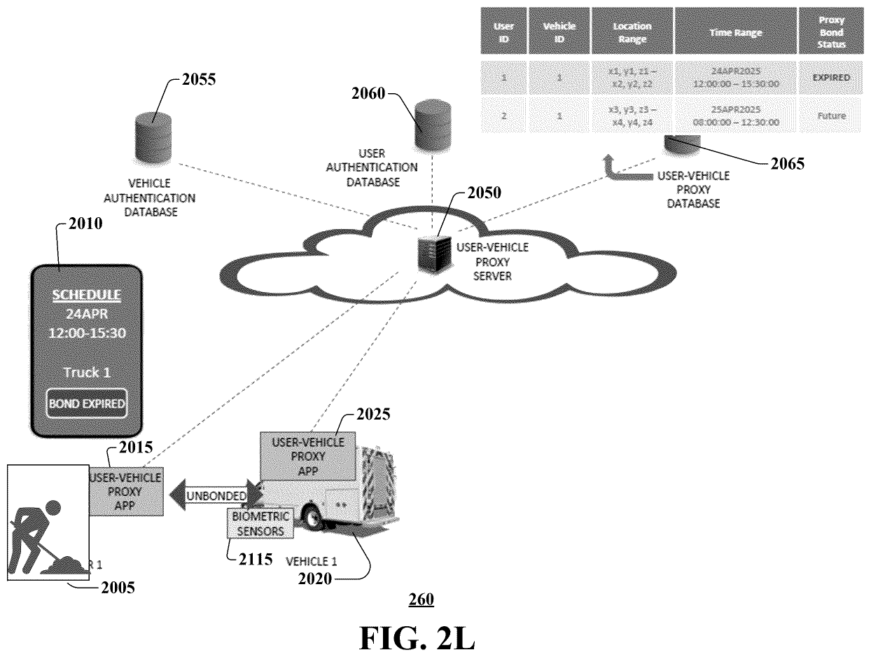

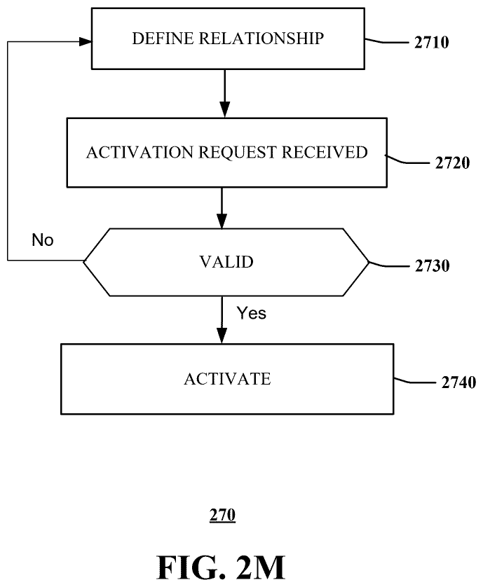

FIG. 2A is a block diagram illustrating an example, non-limiting embodiment of a system 200 functioning within the communication network of FIG. 1 in accordance with various aspects described herein. System 200 can provide for network technician authentication via a connected vehicle. The system 200 includes user 2005, end user device (UE) 2010, User-Vehicle Proxy App (UVPA) 2015, vehicle 2020 (which is an example of equipment of an entity as described herein in the various embodiments), User-Vehicle Proxy App (UVPA) 2025, User-Vehicle Proxy Server (UVPS) 2050, Vehicle Authentication Database (VAD) 2055, User Authentication Database (UAD) 2060, User-Vehicle Proxy Database (UVPD) 2065, User 2070 (which is an example of a customer or other entity for which a service is to be provided as described in the various embodiments herein), end user device (UE) 2075, and customer premises or house 2080 (which is an example of a location or area in which a service is to be provided as described in the various embodiments herein and could be other structures such as a warehouse, stadium, secured area of property, etc.). In one embodiment, user 2005 may interact with UE 2010 and UVPA 2015 to initiate the authentication/bonding relationship process. UVPA 2015 facilitates communication and management of the bonding relationship between user 2005 and vehicle 2020.

In one or more embodiments, the UVPA 2015 can provide a status message indicating that a temporary bonding relationship has been established between user 2005 and vehicle 2020. Vehicle 2020 can be equipped with UVPA 2025, which communicates with UVPS 2050. UVPS 2050 manages the authentication/relationship process and can interact with VAD 2055, UAD 2060, and UVPD 2065 to verify and manage the identities and permissions of user 2005 and vehicle 2020, which can include defining the conditions (or selecting from pre-defined conditions) of the relationship and/or determining whether condition threshold(s) (e.g., time and/or location) have been satisfied. UVPD 2065 can include various information such as user ID, equipment/vehicle ID, location conditions/information (e.g., geofencing or permissible travel areas), time conditions, bonding relationship status (e.g., active, pending, future, expired), and other information that facilitates managing bonding relationships.

In one embodiment, user 2070 can receive a notification via UE 2075, indicating the arrival (or a future arrival including a predicted time period) of the technician (user 2005) and requesting permission to allow access to the premises, such as entrance to a secure gate, opening of an electronic lock, etc. House 2080 represents the customer premises where the service appointment is to take place. The system 200 ensures secure and efficient authentication and access control for user 2005 (e.g., a network service technicians), enabling the user to perform installation or repair tasks at customer premises.

System 200 can enable a convenient and efficient process for a user to provide authentication of a vehicle or other equipment, or vice versa, for various types of applications. For example, the circumstances may exist when a user otherwise has authorization to access a physical location, but needs to make use of the vehicle's communication capabilities to provide a proxy authorization for the vehicle to have access, as well as the user. The bonding relationship can provide other permissions (e.g., shared in whole or in part between the user 2005 and the vehicle 2020), such as access to a subscriber account of the user 2070. System 200 can provide limitations to the existence of this user-to-vehicle bonding and proxy authentication, bounded by conditions, such as time and/or location. These limitations can also be applied to other management of the bonding relationship including expiration, such as when a time has expired and/or a current user/vehicle location is outside of a geofenced area that would include premises 2080.

The example of system 200 is illustrated between a field technician and a vehicle, however, the user can be various types of users that provide services and the vehicle can be various types of equipment (including fixed and mobile equipment). In one or more embodiments, the bonding relationship can be dynamic such as changing based on current conditions including the condition of the equipment, the type of service to be provided, workflow balancing for the entity for which the user in providing the service, and so forth. In one or more embodiments, the bonding relationship can be modular in nature such as providing a relationship between different equipment (which may or may not include a bonding relationship with a user). For instance, the bonding relationship may be between a user, a vehicle, a generator that is to be towed by the vehicle, and radio equipment carried by the vehicle. In this example, a group relationship can be established that allows the user to utilize all of the equipment.

In one or more embodiments, the bonding relationship can be between other equipment operated by other users, such as between a group of vehicles that are providing service to a gated community and need access within the community. In one or more embodiments, the bonding relationship can be between groups of users and/or their equipment, such as between a group of users that are providing service to a sports stadium. In one embodiment the bonding relationship can be applied between a group of users that are associated with different entities that are jointly providing a service, such as field technicians from different companies that are tasked with different part of the service and who work cooperatively together at the location. In one or more embodiments, the bonding relationship can be utilized for controlling particular users that can operate equipment, including field technicians that are permitted to drive vehicles over a certain length while other technicians are limited to driving smaller length vehicles. In one or more embodiments, the bonding relationship can be utilized for controlling particular equipment that can be utilized by a user, such as allowing a field technician to operate a bucket on the vehicle but not permitting the user to operate a welding device where the technician is not certified for welding.

System 200 illustrates a scenario where the bonding relationship is currently active so permissions or proxy authentication can be shared, such as from user 2005 to the vehicle 2020. It should be understood that various other components and functionality can be utilized to facilitate management of the bonding relationships which can be utilized for various services which may or may not be the communications network installation/repair services as shown in FIG. 2A.

FIG. 2B is a block diagram illustrating an example, non-limiting embodiment of a system 210 functioning within the communication network of FIG. 1 in accordance with various aspects described herein. System 210 provides for network technician authentication via a connected vehicle, however, the system can be extended to or otherwise be used by other users and/or other equipment (which may or may not be a vehicle such as a crane at a port, a portable generator, a portable base station, etc.).

The system 210 includes user 2005, UVPA 2015, vehicle 2020, UVPA 2025, UVPS 2050, VAD 2055, UAD 2060, UVPD 2065, and one or more sensors on the equipment/vehicle such as biometric sensor(s) 2115 (which can include a camera and/or microphone). User 2005 interacts with UVPA 2015 to initiate the authentication/bonding relationship process. UVPA 2015 facilitates communication and relationship management between user 2005 and vehicle 2020. For example, the biometric sensor 2115 can collect biometric data (e.g., an image or voice recording such as a response to a particular question) from user 2005 to authenticate the user's identity. Vehicle 2020 is equipped with UVPA 2025, which communicates with UVPS 2050. UVPS 2050 manages the authentication/management process and interacts with VAD 2055, UAD 2060, and UVPD 2065 to verify the identities and permissions of user 2005 and vehicle 2020. The system 210 ensures secure and efficient authentication and access control for network service technicians, enabling them to perform installation or repair tasks at customer premises. It should be understood that system 210 provides an example of the configuration and data flow for managing bonding relationships, however, other configurations and data flows can be implements, such as utilizing short-range communication between the user 2005 and the vehicle 2020 but using cellular communications with the UVPS 2050. In other embodiments, the bonding relationship request can be sent from a UE of the user 2005 rather than, or in conjunction with, an authentication/bonding request from the UVPA 2025 of the vehicle 2020.

In one or more embodiments, system 210 allows a user to be equipped with a device with wireless capabilities, such as a smart phone, wearable, or other such device. The device may also be equipped with a user vehicle proxy app. A vehicle or other equipment may likewise be equipped with wireless connectivity capabilities and a user-vehicle proxy app. The vehicle may also be equipped with biometric sensors that may include cameras, fingerprint sensors, or other biometric sensors that may be used to collect biometric data from a user that is in contact with the sensor or within proximity to the sensor. The user device and the vehicle can also have nearfield communication capabilities, using Bluetooth or other standard NFC protocols. The apps are in communication with a user vehicle proxy server, which in turn, has access to various database information.

In one or more embodiments, system 210 can manage bonding relationships based on dynamic policies such as conditions of the vehicle 2020, conditions of tools on the vehicle (e.g., the welding apparatus is detected as being low on oxy/acetylene fuel), or other variable that change over time and which can be determined or detected. As an example, the vehicle 2020 or other devices can include sensors for detecting conditions and providing information describing the conditions, such as transmitting the information to UVPS 2050 and/or to one of the databases 2055, 2060, 2065. In this example, system 210 can provide for real-time or near-real-time management of the bonding relationships including selecting a different vehicle or equipment to be placed on the vehicle (or instructing a user 2005 to return the vehicle or equipment to the yard after completing the particular installation) when a condition threshold has been surpassed (e.g., vehicle low on fuel). Various techniques can be utilized for the bonding relationship management including applying AI modeling for predicting future conditions, future job requirements, future time periods for performing the work, and so forth. In one or more embodiments, the management of the bonded temporary relationship can include bonding more than one user for the service or replacing the user with a different user for the service. In one or more embodiments, the management of the bonded temporary relationship can analyze certifications, licenses, skills, experience, cost (e.g., where independent contractors are involved), technician workload/schedule; and adjust the relationships accordingly, including replacing users, rearranging scheduled services, adding in other users to assist (e.g., adding a second user that is licensed to operate the heavy equipment), and so forth. In one or more embodiments, the management of the bonded temporary relationship can include locking out or disabling use of a particular tool(s) on a vehicle where a user is not permitted to use the tool. For example, a user can be provided with a vehicle but the bucket may be disabled.

It should be understood that system 210 provides an example of the configuration and data flow for managing bonding relationships, however, other configurations and data flows can be implemented, such as utilizing short-range communication between the user 2005, the bio sensors 2115 and/or the vehicle 2020 but using cellular communications with the UVPS 2050 (e.g., from one or more of those devices). In other embodiments, the biometric information can be captured by the UVPA 2015 of the UE of the user 2005 and sent to the UVPS 2050.

FIG. 2C is a block diagram illustrating an example, non-limiting embodiment of a system 215 functioning within the communication network of FIG. 1 in accordance with various aspects described herein. System 215 provides for network technician authentication via a connected vehicle. The system 215 includes user 2005, UVPA 2015, biometric sensors 2115, vehicle 2020, UVPA 2025, UVPS 2050, VAD 2055, UAD 2060, and UVPD 2065. User 2005 interacts with UVPA 2015 to initiate the authentication/relationship process. UVPS 2050 facilitates communication and relationship management between user 2005 and vehicle 2020. The biometric sensors 2115 collect biometric data from user 2005 to authenticate the user's identity. Vehicle 2020 is equipped with UVPA 2025, which communicates with UVPS 2050. UVPS 2050 manages the authentication process and interacts with VAD 2055, UAD 2060, and UVPD 2065 to verify and manage the identities and permissions of user 2005 and vehicle 2020. The system 215 ensures secure and efficient authentication and access control for network service technicians, enabling them to perform installation or repair tasks at customer premises.

Authentication messaging is illustrated as being sent separately between the UVPA 2015 and UVPS 2050, as well as between UVPA 2025 and UVPS 2050, such as through separate cellular communication sessions. It should be understood that system 215 provides an example of the configuration and data flow for managing bonding relationships, however, other configurations and data flows can be implemented. In other embodiments, the authentication messaging can be sent from a single device, such as first authenticating the UVPA 2015 with the UVPA 2025 and then having one of those UVPAs interact with the UVPS 2050 during authentication messaging.

In one embodiment, system 215 allows for credentials to be stored in a user authentication database that allows for a user to authenticate themselves using the user-vehicle proxy app. Likewise, credentials may be stored in a vehicle authentication database to allow a vehicle to autonomously authenticate itself using the user-vehicle proxy app. In both cases, this authentication can establish an authenticated communication between the user-vehicle proxy app, and the user-vehicle proxy server for both the user and the vehicle.

FIG. 2D is a block diagram illustrating an example, non-limiting embodiment of a system 220 functioning within the communication network of FIG. 1 in accordance with various aspects described herein. System 220 provides for network technician authentication via a connected vehicle. The system 220 includes user 2005, UE 2010, UVPA 2015, biometric sensors 2115, vehicle 2020, UVPA 2025, UVPS 2050, VAD 2055, UAD 2060, and UVPD 2065. User 2005 interacts with UVPA 2015 to initiate the authentication/management process. UVPA 2015, via UE 2010, facilitates communication between user 2005 and vehicle 2020. UE 2010 can provide a schedule that displays the scheduled service appointment details, including the date, time, and vehicle assignment, and provides an option (e.g., a selectable icon) to bond the user 2005 and vehicle 2020. In one embodiment, the UE 2010 can provide other options and information, such as allowing a user 2005 to select from among different vehicles to bond. For instance, the UE 2010 according to data provided by the UVPS 2050 can provide details (which can include images and onboard tools) as to each of the vehicles that are available which can also include capabilities of the vehicle, a history of the user's interaction with a particular vehicle, a past rating/score assigned to the vehicle (e.g., by the user or by other users), and so forth.

Biometric sensors 2115 collect biometric data from user 2005 to authenticate the user's identity. This data is used to ensure that the correct technician is attempting to access the vehicle and perform the service tasks. Vehicle 2020 is equipped with UVPA 2025, which communicates with UVPS 2050. In one embodiment, UVPA 2025 can be solely or jointly responsible for establishing a secure bonding relationship between user 2005 and vehicle 2020 based on various factors including predefined conditions, policies, user qualifications, etc. UVPS 2050 manages the authentication/relationship process and interacts with VAD 2055, UAD 2060, and UVPD 2065 to manage and verify the identities and permissions of user 2005 and vehicle 2020. UVPS 2050 ensures that all conditions for the bonding relationship are met and maintains records of the authentication status. VAD 2055 stores information related to the authentication and authorization of vehicles within the system. UAD 2060 contains data regarding the authentication and authorization of users, such as network service technicians. UVPD 2065 maintains records of the bonding relationships, including user IDs, vehicle IDs, location ranges, time ranges, and the status of the proxy bond. The system 220 ensures secure and efficient authentication and access control for network service technicians, enabling them to perform installation or repair tasks at customer premises.

Authentication messaging is illustrated as being sent separately between the UVPA 2015 and UVPS 2050, as well as between UVPA 2025 and UVPS 2050, such as through separate cellular communication sessions. This messaging is illustrated as utilizing bonding key(s) and condition requirements. Other techniques for authentication and managing bonding relationships can also be employed. It should be understood that system 220 provides an example of the configuration and data flow for managing bonding relationships, however, other configurations and data flows can be implemented. In other embodiments, the authentication keys can be exchanged from device(s) other than UVPS 2050 to add an additional layer of security.

As is further illustrated in FIG. 2D with respect to UVPD 2065, the relationship status can be determined and indicated including for future relationships, which in some embodiments can be determined through application of AI modeling that predicts when a user will complete a first service at a first location and be ready to arrive at and start a second service at a second location. In other embodiments, the status can be shared with various parties including users, dispatchers, customers, etc.

In one embodiment, system 220 provides for a UVPS sending to a vehicle a set of user-vehicle bonding conditions, utilizing or otherwise analyzing the data stored by the databases including a user-vehicle proxy database. In this manner, a user has, in effect, a key that may be used to create a bonding relationship between the user and the vehicle at the permitted time and location range (and which can include other conditions). The vehicle has data which allows it to know that a bond may be created between the user and the vehicle at a time within the time range and location range (or other conditions). In addition, a user-vehicle proxy server may retrieve user authentication data corresponding to the user from a user authentication database. This may include, for example, a password or other credentials, or biometric data for the user such that when user attempts to establish a bond with the vehicle, then the vehicle can authenticate the credentials that the user is presenting.

FIG. 2E is a block diagram illustrating an example, non-limiting embodiment of a system 225 functioning within the communication network of FIG. 1 in accordance with various aspects described herein. System 225 provides for network technician authentication via a connected vehicle. The system 225 includes user 2005, UE 2010, UVPA 2015, vehicle 2020, UVPA 2025, biometric sensors 2115, UVPS 2050, VAD 2055, UAD 2060, and UVPD 2065. User 2005 interacts with UVPA 2015 to initiate the authentication/management process. UVPA 2015 facilitates communication between user 2005 and vehicle 2020. The UE 2010 can provide a schedule that is displayed with the scheduled service appointment details, including the date, time, and vehicle assignment, and can provide an option to bond the user and vehicle. Vehicle 2020 is equipped with UVPA 2025, which communicates with UVPS 2050. UVPA 2025 ensures secure communication between the vehicle 2020 and the server 2050. Biometric sensors 2115 collect biometric data from user 2005 to authenticate the user's identity. This data can be used to ensure that the correct technician is attempting to access the vehicle and perform the service tasks. In one embodiment, UVPA 2025 can be responsible (in whole or in part) for establishing a secure bonding relationship between the user 2005 and vehicle 2020 based on various information including policies and predefined conditions. UVPS 2050 can select or define the conditions for the bonding relationship between the technician and the vehicle. These conditions may include specific time frames, locations, permissions, and the presence of a third-party authenticator. UVPS 2050 manages the authentication/relationship process and interacts with VAD 2055, UAD 2060, and UVPD 2065 to manage and verify the identities, permissions and relationship of and between user 2005 and vehicle 2020. VAD 2055 stores information related to the authentication and authorization of vehicles within the system 225. UAD 2060 contains data regarding the authentication and authorization of users, such as network service technicians. UVPD 2065 maintains records of the bonding relationships, including user IDs, vehicle IDs, location ranges, time ranges, and the status of the proxy bond. The system 225 ensures secure and efficient authentication and access control for network service technicians, enabling them to perform installation or repair tasks at customer premises.

FIG. 2E illustrates a status of pending that is stored in the UVPD 2065 which can indicate that the bond has not yet fully been provided or initiated, such as where the time condition is satisfied but the user has not yet arrived at the location. Pending can also represent other scenarios such as another condition not yet being satisfied (e.g., awaiting power being turned off of a circuit before work is to be performed to power lines). In one embodiment, the pending status can be used in conjunction with an option presented at the UE 2010 for the user 2005 to accept the bonding relationship and can remain pending until the option is selected or until the conditions no longer apply (e.g., time and/or location conditions).

In one embodiment, system 225 provides that within an allowed time and location range, a user may initiate a bond request with a vehicle. This may be performed in a number of ways. In one case, the user may activate an option on the proxy app and send key data to the vehicle, which is over a near field communication within proximity of the vehicle. In another example, the app may autonomously send the key to the vehicle when the user is in a proximate range of the vehicle. In another manner, the user may present their biometric data, such as a fingerprint or facial image recognition either to a sensor on the user's device or a biometric sensor on the vehicle itself, which is activated when the vehicle detects the presence of the user app within a proximate range.

In one or more embodiments, system 225 is not limited to vehicle-user bonds but rather can be other types of bonds between other objects including tools, medical equipment, etc. where the particular object can then be provided with authorization or permission to perform functions that the user is authorized to perform.

FIG. 2F is a block diagram illustrating an example, non-limiting embodiment of a system 230 functioning within the communication network of FIG. 1 in accordance with various aspects described herein. System 230 provides for network technician authentication via a connected vehicle. The system 230 includes user 2005, UVPA 2015, vehicle 2020, UVPA 2025, biometric sensors 2115, UVPS 2050, VAD 2055, UAD 2060, and UVPD 2065. User 2005 interacts with UVPA 2015 to initiate the authentication/management process. UVPA 2015 facilitates communication between user 2005 and vehicle 2020. The biometric sensors 2115 collect biometric data from user 2005 to authenticate the user's identity. Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2005 and vehicle 2020. The system 230 ensures secure and efficient authentication and access control for network service technicians, enabling them to perform installation or repair tasks at customer premises.

FIG. 2F illustrates a status change to Active that is stored in the UVPD 2065 which can indicate that the bond has been established, such as where all necessary conditions are satisfied (and/or the user 2005 has selected the option to accept the bond). In one embodiment, this can occur before the vehicle arrives at the customer premises, such as at a predicted time so that the vehicle can gain access to a gated community, etc. Active status can also represent other scenarios such active as to certain permissions but not active as to other permissions, such as allowing entrance into the gated community at 8:30 a.m. but waiting to allow use of the generator until 9 a.m. per Home Owner Association noise rules.

In one embodiment, system 230 provides that a vehicle authenticates a user and the system authenticates a location range in a time range as satisfying the user-vehicle bonding conditions, which enables establishing the bond between the user and the vehicle. The bonding relationship between the user and vehicle can be updated to active in the user-vehicle proxy database. At this point, the user and vehicle may be viewed as being equally authenticated, and may therefore authenticate one another in a proxy manner as needed by applications using this arrangement.

In one embodiment, system 230 allows for on-demand functionality to be added to the relationship, such as a determination being made during an installation service that welding will be required and adding that permission (i.e., to utilize the welding tool) during the service based on determining that the user is qualified to utilize the welder. Other on-demand functionality and permissions can be added, such as operating particular tools or accessing particular information associated with a customer which at the time of the original defining of the relationship may not have been required but due to detecting changed circumstances is now required. In one embodiment, system 230 allows for a user and vehicle to share functionality levels based on the bonding relationship, such as a being granted permission to access subscriber data on the user's UE then causing the vehicle computing system to also be able to access this same subscriber data.

FIG. 2G is a block diagram illustrating an example, non-limiting embodiment of a system 235 functioning within the communication network of FIG. 1 in accordance with various aspects described herein. System 235 provides for network technician authentication via a connected vehicle. The system 235 includes user 2005, UVPA 2015, vehicle 2020, UVPA 2025, biometric sensors 2115, UVPS 2050, VAD 2055, UAD 2060, and UVPD 2065. User 2005 interacts with UVPA 2015 to initiate the authentication/management process. UVPA 2015 facilitates communication between user 2005 and vehicle 2020. The biometric sensors 2115 collect biometric data from user 2005 to authenticate the user's identity. Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2005 and vehicle 2020. The system 235 ensures secure and efficient authentication and access control for network service technicians, enabling them to perform installation or repair tasks at customer premises.

The bonding relationship ensures that the correct technician is attempting to access the vehicle, access the premises 2080, and perform the service tasks. House 2080 represents the customer premises where the service appointment is to take place. The system 235 ensures secure and efficient authentication and access control for network service technicians including by providing access codes (e.g., temporarily re-programming a programmable RFID of the vehicle 2020 that can be read by a gate to open the gate in a gated community), enabling them to perform installation or repair tasks at the customer premises.

In one embodiment, system 235 provides that a user is authorized to access a physical location, but may need to use vehicle's capabilities to communicate with the physical location to unlock and provide access to the physical location. For example, a vehicle may have the capability to communicate with an access point, such as a gated community, a garage, a parking facility, or other such location whereby the vehicle may communicate using infrared or other mechanisms with an access point or sensor reader. As another example, a vehicle may have the ability to create and present a QR code to a reader. In this case, the user has authentication to access the location, but the vehicle has the ability to communicate that authentication. Therefore, the vehicle may use its bonding relationship to provide access for itself and the user. Without the bonding relationship in place, the access point may detect the presence of the user but block access to the vehicle. This example of passing of access or permissions can go in either direction, such as where a vehicle has authorized access but the driver does not and so the bonding relationship therefore grants the shared access rather than a security guard requesting ID from the driver and having the driver go through a separate authentication process.

FIG. 2H is a block diagram illustrating an example, non-limiting embodiment of a system 240 functioning within the communication network of FIG. 1 in accordance with various aspects described herein. System 240 provides for network technician authentication via a connected vehicle. The system 240 includes user 2005, UVPA 2015, vehicle 2020, UVPA 2025, biometric sensors 2115, UVPS 2050, VAD 2055, UAD 2060, and UVPD 2065. User 2005 interacts with UVPA 2015 to initiate the authentication/management process. UVPA 2015 facilitates communication between user 2005 and vehicle 2020. The biometric sensors 2115 collect biometric data from user 2005 to authenticate the user's identity. Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2005 and vehicle 2020. The system 240 ensures secure and efficient authentication and access control for network service technicians, enabling them to perform installation or repair tasks at customer premises.

Vehicles 2400 represents additional vehicles that can communicate with vehicle 2020 and be bonded to the vehicle 2020 and/or to user 2005. The system 240 ensures secure and efficient authentication and access control for multiple users such as network service technicians, enabling them to perform installation or repair tasks at customer premises. As an example, the process of establishing the bonding relationship described with respect to FIG. 2A-2G can be repeated in whole or in part or can be modified to facilitate providing a temporary relationship to each of the vehicles 2400. These temporary relationships can be the same (e.g., each user and vehicle has the same level of permissions) or can be different, such as providing a temporary relationship between vehicles 2400 and vehicle 2020 (or user 2005) that allows gate access but does not allow access to subscriber data (while user 2005 and vehicle 2020 still retains access to the subscriber data). In other embodiments, the vehicles 2020 and 2040 can have multiple relationships active at any given time. For example, vehicle 2040 may have a first bonding relationship with its own driver/technician to allow for use of tools on vehicle 2040 by that particular driver/technician and a second bonding relationship with vehicle 2020 in order to obtain gate access to the premises. In other embodiments, permissions can be selectively granted or denied depending on the circumstances, such as providing user 2005 with a permission to use the welding machine on vehicle 2040 where vehicle 2020 is not equipped with a welding machine. As described with respect to the embodiments herein, various techniques can be utilized to manage the relationships, including determining the particular permissions that are to be granted, including by applying AI modeling to various data associated with the services, the premises, the users, the vehicles, the equipment or other factors including network or infrastructure conditions.

In one embodiment, system 240 provides access to vehicle-to-vehicle communications and data content. This may be, for example, to enable communications between other members of a vehicle fleet. Similarly, a user may provide the authentication credentials and a vehicle may provide the means, functionality or components to communicate those credentials. This may, for example, prevent an unauthorized user of a vehicle from being able to engage in vehicle-to-vehicle communication to access sensitive information.

In one embodiment, system 240 provides a mini or mesh network of vehicles and/or users in an area which can be a work area, such as after a hurricane or in other situations such as for first responders during an emergency event. The network can communicate by various techniques including one or more of short-range communications (e.g., nearby Wifi), satellite, cellular, etc. In one embodiment, a mesh network via the bonding relationships relying on short-range or satellite communications can be employed where cellular coverage is out in a particular area. In one embodiment, daisy chain access can be provided amongst the vehicles and/or users. In other embodiments, system 240 allows vehicle-to-vehicle communication to be long range communications, such as cellular.

FIG. 2I is a block diagram illustrating an example, non-limiting embodiment of a system 245 functioning within the communication network of FIG. 1 in accordance with various aspects described herein. System 245 provides for network technician authentication via a connected vehicle. The system 245 includes user 2450, UVPA 2015, vehicle 2020, UVPA 2025, biometric sensors 2115, UVPS 2050, VAD 2055, UAD 2060, UVPD 2065, and premises 2080. In one embodiment, user 2450 interacts with UVPA 2015 to initiate the authentication/management process. UVPA 2015 facilitates communication between user 2450 and vehicle 2020, which in this example the user seeking the bonding relationship may not be the driver but rather an office person. The biometric sensors 2115 can still collect biometric data such as from a driver (not shown) to authenticate the driver's identity. In other embodiments, the vehicle 2020 or other equipment may be autonomous or remotely controlled including a drone (e.g., dispatched to survey damage to infrastructure). Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2450 and vehicle 2020. The system 245 ensures secure and efficient authentication and access control for office analysts and/or network service technicians, enabling them to perform or facilitate installation or repair tasks at customer premises 2080.

In one embodiment of system 245, the bonding relationship between user and vehicle that has been described may also exist between a remote user, for example, in a control center, and an autonomous vehicle. In such an arrangement, supplementary communication mechanisms may be established such that the user may be represented as though they were in the vehicle. For example, by establishing the bonding relationship, the proxy apps may establish a communication path that permits the user to communicate as necessary via the vehicle. For example, a voice path may be established between the user and the vehicle, such that, if the autonomous vehicle encounters any condition requiring human interaction, the user may use the communication path to conduct a spoken or video communication via the vehicle as needed. For instance, a drone surveying an area after hurricane damage may be provided with voice communication capability (at the drone) to warn individuals in the area that downed power lines are dangerous and the individuals should leave the area.

System 245 is illustrated and described with a user that may be operating a remotely controlled or autonomous vehicle 2020, however, user 2450 can be an office analyst provided with a bonding relationship with a field technician who is bonded with the vehicle 2020 so that both users can work on the service including solving any issues that may arise during an inspection. The permissions in this example granted to user 2450 may include access to cameras or other sensors on the vehicle 2020, access to a subscriber account, access to performance metrics associate with network elements providing services at the premises 2080, and so forth.

FIG. 2J is a block diagram illustrating an example, non-limiting embodiment of a system 250 functioning within the communication network of FIG. 1 in accordance with various aspects described herein. System 250 provides for network technician authentication via a connected vehicle. The system 250 includes user 2005, UE 2010, UVPA 2015, vehicle 2020, UVPA 2025, UVPS 2050, VAD 2055, UAD 2060, UVPD 2065, customer 2070, UE 2075, and customer premises 2080. User 2005 interacts with UVPA 2015 to initiate the authentication/management process. UVPA 2015 facilitates communication between user 2005 and vehicle 2020. Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2005 and vehicle 2020. The system 250 ensures secure and efficient authentication and access control for network service technicians, enabling them to perform installation or repair tasks at customer premises.

User 2070 (e.g., a customer) receives a notification via UE 2075 indicating that the installer will arrive at about 2:00 today. House 2080 represents the customer premises where the service appointment is to take place. The system 250 ensures secure and efficient authentication and access control for network service technicians, enabling them to perform installation or repair tasks at customer premises.

In one embodiment, system 250 provides for a third-party authenticator to permit proxy authentication to take place. This may also involve other conditions, such as the request for proxy authentication taking place at or about an expected time. As an example, an expected time for the bonded proxy authentication request may be established and communicated to a third-party. For instance, this may be a residential homeowner, expecting a repair or installation appointment.

In one or more embodiments, the bonding relationship can extend beyond vehicles and tools. For example, user 2005 and/or vehicle 2020 may be provided a bonding relationship with equipment that is not owned or not managed by the entity (for which the technician is performing the service). For instance, a bonding relationship may be established between the user 2005 and a smart meter or other customer premises equipment (which may be third party equipment or may be equipment owned by the customer). In this example, the user 2005 would be granted particular permission associated with the smart meter, such as access to log files, measurements, communications to and from the smart meter, a repair history, and so forth, which may facilitate performing the service associated with the customer premises.

FIG. 2K is a block diagram illustrating an example, non-limiting embodiment of a system 255 functioning within the communication network of FIG. 1 in accordance with various aspects described herein. System 255 provides for network technician authentication via a connected vehicle. The system 255 includes user 2005, UE 2010, UVPA 2015, vehicle 2020, UVPA 2025, UVPS 2050, VAD 2055, UAD 2060, UVPD 2065, customer 2070, UE 2075, and customer premises 2080. User 2005 interacts with UVPA 2015 to initiate the authentication/management process. UVPA 2015 facilitates communication between user 2005 and vehicle 2020. Vehicle 2020 is equipped with UVPA 2025, which communicates with UVPS 2050. UVPS 2050 manages the authentication/relationship process and interacts with VAD 2055, UAD 2060, and UVPD 2065 to verify the identities, permissions and relationships of and between user 2005 and vehicle 2020. The system 255 ensures secure and efficient authentication and access control for network service technicians, enabling them to perform installation or repair tasks at customer premises.

User 2070 receives a notification via UE 2075 indicating the arrival of the technician and requesting permission to access the premises. As an example, an option can be presented on the UE 2075 for admitting the user 2005 and/or the vehicle 2020. For instance, depressing the Admit option can trigger opening of an electronic lock at the premises 2080, opening of a gate at a gated community, or otherwise interacting with a home security or HOA community system for providing physical access. House 2080 represents the customer premises where the service appointment is to take place. The system 255 ensures secure and efficient authentication and access control for network service technicians, enabling them to perform installation or repair tasks at customer premises.

In one embodiment of system 255, at a time when the installer arrives and submits, the proxy authentication request, even though the bonding relationship continues to exist between the user and the vehicle since it is within an allowed location range of time range, a subsequent, third-party authentication request may be sent. Once the authentication request is acknowledged, the access may be permitted.

FIG. 2L is a block diagram illustrating an example, non-limiting embodiment of a system 260 functioning within the communication network of FIG. 1 in accordance with various aspects described herein. System 260 provides for network technician authentication via a connected vehicle. The system 260 includes user 2005, UE 2010, UVPA 2015, biometric sensors 2115, vehicle 2020, UVPA 2025, UVPS 2050, VAD 2055, UAD 2060, and UVPD 2065. User 2005 interacts with UVPA 2015 to initiate the authentication/management process. UVPA 2015, via UE 2010, facilitates communication between user 2005 and vehicle 2020. UE 2010 can provide or present a schedule that displays the scheduled service appointment details, including the date, time, and vehicle assignment, such as based on data provided by the UVPS 2050.

Biometric sensors 2115 collect biometric data from user 2005 to authenticate the user's identity. This data is used to ensure that the correct technician is attempting to access the vehicle and perform the service tasks. Vehicle 2020 is equipped with UVPA 2025, which communicates with UVPS 2050. In one embodiment, UVPA 2025 can be solely or jointly responsible for establishing a secure bonding relationship between user 2005 and vehicle 2020 based on various factors including predefined conditions, policies, user qualifications, etc. UVPS 2050 manages the authentication/relationship process and interacts with VAD 2055, UAD 2060, and UVPD 2065 to manage and verify the identities and permissions of user 2005 and vehicle 2020. UVPS 2050 ensures that all conditions for the bonding relationship are met and maintains records of the authentication status. VAD 2055 stores information related to the authentication and authorization of vehicles within the system. UAD 2060 contains data regarding the authentication and authorization of users, such as network service technicians. UVPD 2065 maintains records of the bonding relationships, including user IDs, vehicle IDs, location ranges, time ranges, and the status of the proxy bond. The system 260 ensures secure and efficient authentication and access control for network service technicians, enabling them to perform installation or repair tasks at customer premises.

The UE 2010 provides a notification as to when a bonding relationship has expired or otherwise become deactivated. This notification can be provided or presented via other computing devices, including in a vehicle communication system of the vehicle 2020. This is also indicated by information stored in UVPD 2065. The expiration or deactivation can be triggered based on various determinations or factors. For example, once the time conditions or location conditions are no longer satisfied then the UVPS 2050 may cause the bonding relationship to expire (including removing any granted permissions). In other embodiments, completion of the service (which can be manually confirmed by the user 2005 sending a message to a dispatcher/office or which can be automatically detected such as detecting resumed operations at the premises) can be the trigger for the UVPS 2050 to deactivate the bonding relationship.

In one embodiment, system 260 provides that user-vehicle proxy apps may constantly monitor the time and location (or other conditions) of the user and vehicle. If the vehicle exits the location range coordinates or the time range of the bonding expires (or other conditions are no longer met), the bonding relationship between the user in the vehicle is unbonded, the proxy database is updated accordingly, and the user (and/or others) is notified.

In one or more embodiments, bonding relationships can be activated and deactivated per job, including within the time period that a service is being performed (e.g., after completion of using a first piece of equipment but before the service is complete). This can be particularly useful where the bonding relationship is modular or otherwise exists between multiple pieces of equipment which may be moved to and from the premises at different times. Similarly, bonding relationships can be activated and deactivated per truck, including within the time period that a service is being performed (e.g., after a first truck completes its work and leaves the premises the bonding relationship for the first truck can be deactivated while the bonding relationship for a second truck that is still at the premises may remain active).

FIG. 2M depicts an illustrative embodiment of a method 270 in accordance with various aspects described herein. Method 270 can be utilized by various users for various equipment including vehicles to facilitate performance of various services, such as field technicians that are performing installation or repair at a remote location (e.g., a secure customer premises). Method 270 includes defining and activating a bonding relationship between users and equipment, which in this example is described as a field technician and a vehicle but could be other types of users and other types of equipment, including mobile equipment and fixed equipment. The method 270 can be implemented by various devices or combinations of devices in a centralized or distributed fashion, including via a server having a processing system including one or more processors.

At 2710, the method 270 defines the relationship between the user and the vehicle. This can involve generating conditions such as time and location for the allowed bonding relationship. For example, the relationship may only allow the field technician to utilize the vehicle in a geofenced area that includes the customer premises (and roads to get to the customer premises). At 2720, the method 270 receives or otherwise obtains an activation request for the defined relationship. This request can be sent in a number of different ways, such as from a communication device associated with the user (e.g., the user's mobile phone or tablet), a vehicle communication system, a computing device of the user, and so forth.

At 2730, the method 270 can validate the received activation request. The validation process can check if the request and other circumstances associated with the user and/or vehicle (or other equipment) meets predefined conditions and/or any other requirements, policies or rules, which can include dynamic requirements such as workload balancing that is adjusted on a daily or hourly basis. Other requirements, policies, and rules can be applied as part of determining whether to activate the relationship, including user qualifications (e.g., a user's certification for operating a tool or equipment), equipment conditions (which can be monitored in real-time or near-real-time), and so forth. At 2740, the method 270 activates the allowed bonding relationship based on the successful validation. The activation can then be stored in the system, indicating that the bonding relationship has been created.

While for purposes of simplicity of explanation, the respective processes are shown and described as a series of blocks in FIG. 2M, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

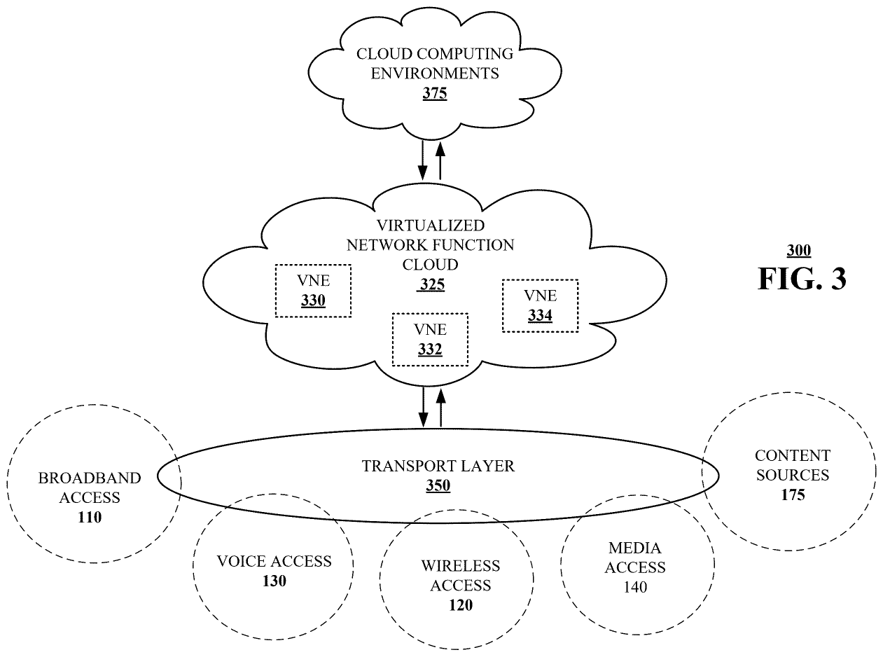

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described herein. For example, virtualized communication network 300 can facilitate in whole or in part defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads. Various protocols and standards can be applied or serve as guidance for one or more of the exemplary embodiments, including features described with respect to 3GPP Standard, European Telecommunications Standards Institute (ETSI), and so forth.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, User Plane Functions (UPF) and/or Access and Mobility management Functions (AMF), broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

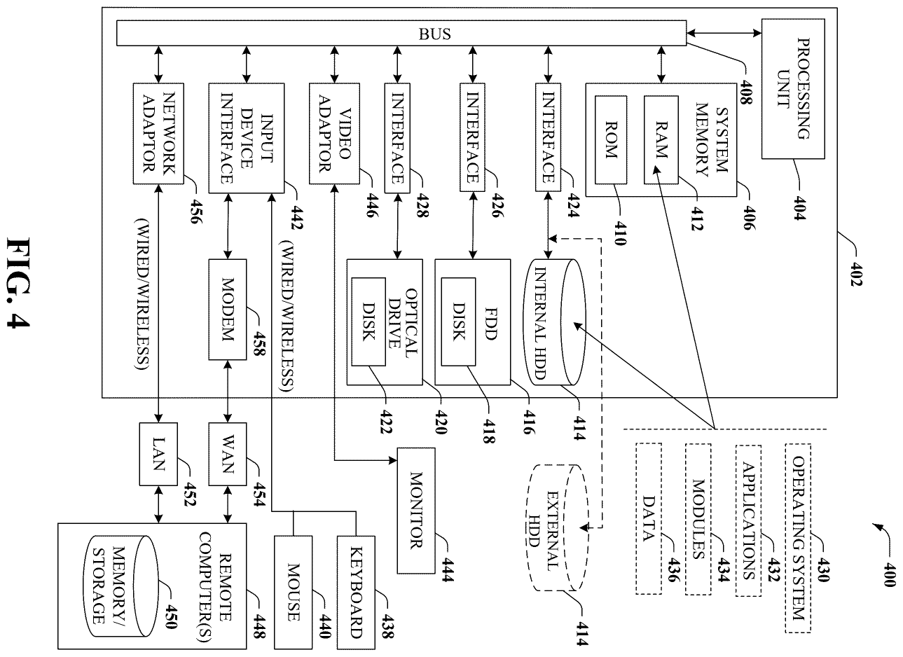

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

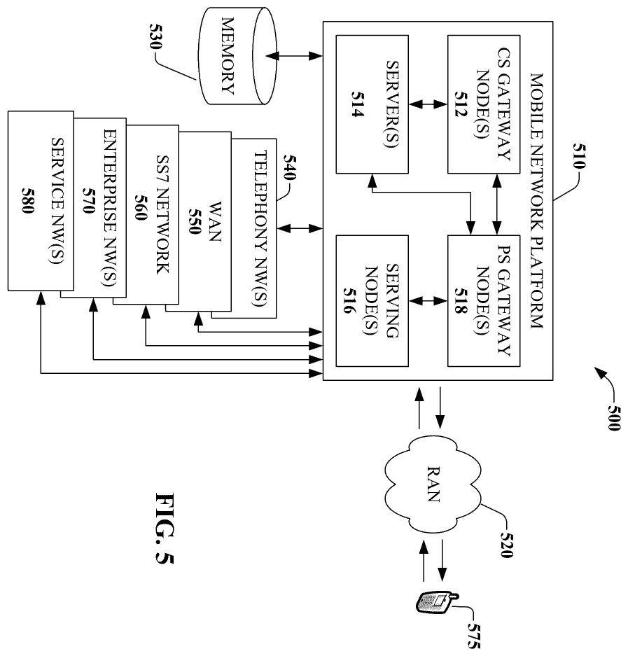

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

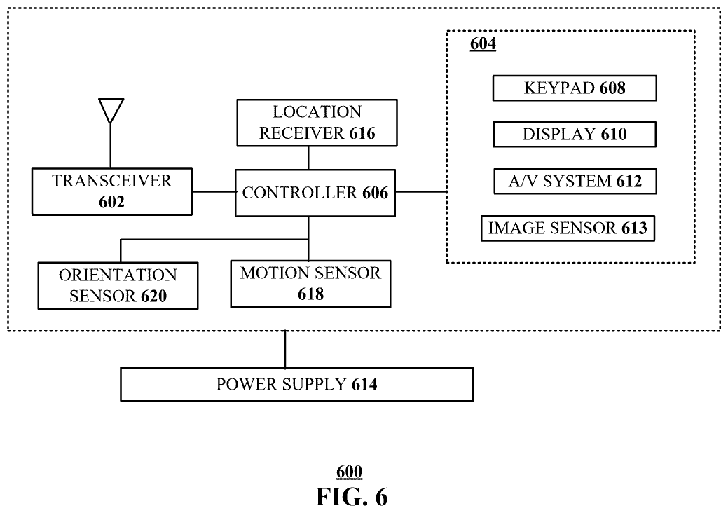

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part defining an allowed bonding relationship between a user and equipment of an entity, where the defining the allowed bonding relationship includes generating a time condition and a location condition, accessing a user profile identifying user qualifications for the user, accessing policies associated with qualifications required for particular permissions associated with the equipment, and applying the policies to the user qualifications; receiving, from an end user device of the user, a request to activate the allowed bonding relationship; validating the request; activating the allowed bonding relationship based on the validating, the time condition and the location condition; and storing activation information indicating that the allowed bonding relationship has been created.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, data associated with at least one of a user or a vehicle;
defining, by the processing system and according to the data, an allowed bonding relationship between the user and the vehicle, wherein the defining the allowed bonding relationship includes generating a time condition and a location condition;
receiving, by the processing system from a communication device, a request to activate the allowed bonding relationship;
validating, by the processing system, the request;
activating, by the processing system, the allowed bonding relationship based on the validating; and
storing, by the processing system, activation information indicating that the allowed bonding relationship has been created.

2. The method of claim 1, comprising:
providing, by the processing system, a proxy authentication to the vehicle according to the allowed bonding relationship, the proxy authentication providing permissions for the vehicle that have been previously provided to the user.

3. The method of claim 2, wherein the user is a field technician, wherein the communication device is an end user device of the field technician, and wherein the permissions include access to a customer premises.

4. The method of claim 3, wherein the permissions include access by a vehicle computing system to an account associated with the customer premises.

5. The method of claim 4, comprising:
monitoring, by the processing system, time and location associated with at least one of the field technician or the vehicle;
deactivating, by the processing system, the allowed bonding relationship based on the monitoring; and
storing, by the processing system, deactivation information indicating that the allowed bonding relationship has expired.

6. The method of claim 1, wherein the defining the allowed bonding relationship includes: accessing a user profile identifying user qualifications for the user, accessing policies associated with qualifications required for particular permissions, and applying the policies to the user qualifications.

7. The method of claim 1, wherein at least one of the receiving the data or the validating of the request is based on a biometric authentication condition.

8. The method of claim 1, wherein the communication device is an end user device of the user, wherein biometric information for the user is obtained via at least one of the end user device or a vehicle computing system of the vehicle.

9. The method of claim 1, wherein a proxy authentication is exchanged between the user and the vehicle according to the allowed bonding relationship, the proxy authentication providing permissions from one of the user or vehicle to the other of the user or vehicle. wherein the proxy authentication includes exchanging a unique authentication token.

10. The method of claim 9, wherein the exchanging of the unique authentication token from one of the user or vehicle to the other of the user or vehicle is via nearfield communication.

11. The method of claim 1, comprising:
monitoring, by the processing system, a location associated with at least one of the user or the vehicle, wherein the activating of the allowed bonding relationship is based on geofencing applied to the monitoring of the location.

12. The method of claim 11, comprising:
deactivating, by the processing system, the allowed bonding relationship based on the monitoring and the geofencing; and
storing, by the processing system, deactivation information indicating that the allowed bonding relationship has expired.

13. A device, comprising:
a processing system including a processor; and
a memory that stores executable instructions that, when executed by the processing system, facilitate performance of operations, the operations comprising:
defining an allowed bonding relationship between a user and equipment of an entity, wherein the defining the allowed bonding relationship includes generating a time condition and a location condition, accessing a user profile identifying user qualifications for the user, accessing policies associated with qualifications required for particular permissions associated with the equipment, and applying the policies to the user qualifications;
receiving, from an end user device of the user, a request to activate the allowed bonding relationship;
validating the request;
activating the allowed bonding relationship based on the validating, the time condition and the location condition; and
storing activation information indicating that the allowed bonding relationship has been created.

14. The device of claim 13, wherein the operations further comprise:
monitoring a location associated with the equipment, wherein the activating of the allowed bonding relationship is based on geofencing applied to the monitoring of the location.

15. The device of claim 14, wherein the operations further comprise:
deactivating the allowed bonding relationship based on the monitoring and the geofencing; and
storing deactivation information indicating that the allowed bonding relationship has expired.

16. The device of claim 13, wherein the equipment is first equipment, and wherein the operations further comprise:
monitoring a condition associated with the first equipment;
determining that a different equipment should be used according to the monitoring of the condition; and
responsive to the determining that a different equipment should be used, defining another allowed bonding relationship between the user and second equipment of the entity.

17. The device of claim 13, wherein the equipment is one or a vehicle or a tool associated with a vehicle.

18. A non-transitory machine-readable medium, comprising executable instructions that, when executed by a processing system including a processor, facilitate performance of operations, the operations comprising:
defining an allowed bonding relationship between a user and a vehicle, wherein the defining the allowed bonding relationship includes generating a time condition and a location condition;
receiving, from a communication device, a request to activate the allowed bonding relationship;
validating the request;
activating the allowed bonding relationship based on the validating, the time condition and the location condition; and
storing activation information indicating that the allowed bonding relationship has been created.

19. The non-transitory machine-readable medium of claim 18, wherein the operations further comprise monitoring a location associated with at least one of the user or vehicle, wherein the activating of the allowed bonding relationship is based on geofencing applied to the monitoring of the location.

20. The non-transitory machine-readable medium of claim 19, wherein the operations further comprise:
deactivating the allowed bonding relationship based on the monitoring and the geofencing; and
storing deactivation information indicating that the allowed bonding relationship has expired.
